(19) United States
(12) Patent Application Publication
(10) Pub. No.: US 2026/0146548 A1
(43) Pub. Date: May 28, 2026

(54) CONTROL DEVICE FOR INTERNAL COMBUSTION ENGINE

(71) Applicant: TOYOTA JIDOSHA KABUSHIKI KAISHA, Toyota-shi (JP)

(72) Inventor: Shinji HARADA, Toyota-shi (JP)

(73) Assignee: TOYOTA JIDOSHA KABUSHIKI KAISHA, Toyota-shi (JP)

(21) Appl. No.: 19/285,211

(22) Filed: Jul. 30, 2025

(30) Foreign Application Priority Data
Nov. 28, 2024 (JP) 2024-206977

(51) Int. Cl. F01M 1/08; F02D 41/00; F02D 41/04

(52) U.S. Cl. CPC F01M 1/08; F02D 41/0002; F02D 41/042; F02D 2200/0614; F02D 2200/70

(57) ABSTRACT

The control device is applied to an internal combustion engine including an oil jet that injects oil onto a back surface of a piston or an inner wall of a cylinder. The control device includes a processing circuit that controls an intake pressure of the internal combustion engine and an oil injection amount of the oil jet and stops the internal combustion engine based on a command to stop the internal combustion engine. When the command to stop the internal combustion engine is issued, the processing circuit executes an intake pressure decrease process and an oil injection amount increase process under a condition that there is a possibility of condensed water freezing in a combustion chamber of the internal combustion engine after the stop. The processing circuit stops the internal combustion engine after the intake pressure decrease processing and the oil injection amount increase processing are ended.

### CROSS-REFERENCE TO RELATED APPLICATION

This application claims priority to Japanese Patent Application No. 2024-206977 filed on Nov. 28, 2024. The disclosure of the above-identified application, including the specification, drawings, and claims, is incorporated by reference herein in its entirety.

### BACKGROUND

### 1. Technical Field

The present disclosure relates to a control device for an internal combustion engine.

### 2. Description of Related Art

As disclosed in Japanese Unexamined Patent Application Publication No. 2018-178839 (JP 2018-178839 A), it is known that condensed water is accumulated in an intake system of an internal combustion engine after the internal combustion engine is stopped, and thus the condensed water is frozen in an environment with a low outside air temperature. In addition, the condensed water is accumulated not only in the intake system of the internal combustion engine but also in a combustion chamber. In particular, in an internal combustion engine that uses hydrogen as fuel, condensed water is likely to accumulate in a combustion chamber.

### SUMMARY

When condensed water accumulated in a combustion chamber enters a groove for housing a piston ring in a piston, the condensed water in the groove is frozen during engine stop in an environment with a low outside air temperature. When the condensed water in the groove of the piston ring is frozen as described above, a behavior of the piston ring after a next start of an internal combustion engine is inhibited, and thus the piston ring cannot be properly operated after the start of the internal combustion engine. When the piston ring cannot be properly operated, there is a possibility that a compression failure of a gas in the combustion chamber occurs and misfire occurs.

A control device according to a first aspect of the present disclosure is applied to an internal combustion engine including an oil jet configured to inject oil onto a back surface of a piston or an inner wall of a cylinder. The control device includes a controller configured to control an intake pressure of the internal combustion engine and an oil injection amount of the oil jet and stop the internal combustion engine based on a command to stop the internal combustion engine. The controller is configured to execute, when the command to stop the internal combustion engine is issued, an intake pressure decrease process and an oil injection amount increase process, under a condition that there is a possibility of condensed water freezing in a combustion chamber of the internal combustion engine after the internal combustion engine is stopped. The intake pressure decrease process is a process of decreasing the intake pressure of the internal combustion engine. The oil injection amount increase process is a process of increasing the oil injection amount of the oil jet. The controller is configured to stop the internal combustion engine after the intake pressure decrease process and the oil injection amount increase process are ended.

With the above configuration, when the command to stop the internal combustion engine is issued, the intake pressure decrease process and the oil injection amount increase process are executed in a case where there is a possibility of the condensed water freezing in the combustion chamber of the internal combustion engine after the internal combustion engine is stopped. In the intake pressure decrease process, the pressure in the combustion chamber is also decreased as the intake pressure of the internal combustion engine is decreased. Then, after the intake pressure decrease process and the oil injection amount increase process are ended, the internal combustion engine is stopped. Oil is caused to enter the combustion chamber by the decrease in the intake pressure of the internal combustion engine due to the intake pressure decrease process and the increase in the oil injection amount of the oil jet due to the oil injection amount increase process. As a result, the groove for housing a piston ring in a piston is filled with the oil, and thus the oil is mixed with the condensed water that has entered the groove of the piston. In this way, the condensed water in the groove is mixed with the oil, so that a freezing point of the condensed water in the groove is lowered, and thus the freezing of the condensed water in the groove of the piston during the engine stop in an environment with a low outside air temperature can be reduced. In addition, a malfunction of the piston ring due to the freezing of the condensed water in the groove of the piston can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an internal combustion engine and a control device thereof;

FIG. 2 is a cross-sectional view showing an outer peripheral surface of a head portion of a piston in the internal combustion engine of FIG. 1 in an enlarged manner;

FIG. 3 is a flowchart showing a procedure for stopping the autonomous operation of the internal combustion engine of FIG. 1; and

FIG. 4 is a time chart showing a transition of cumulative values of the coolant temperature and the fuel injection amount with the passage of time.

### DETAILED DESCRIPTION OF EMBODIMENTS

Hereinafter, an embodiment of a control device for an internal combustion engine

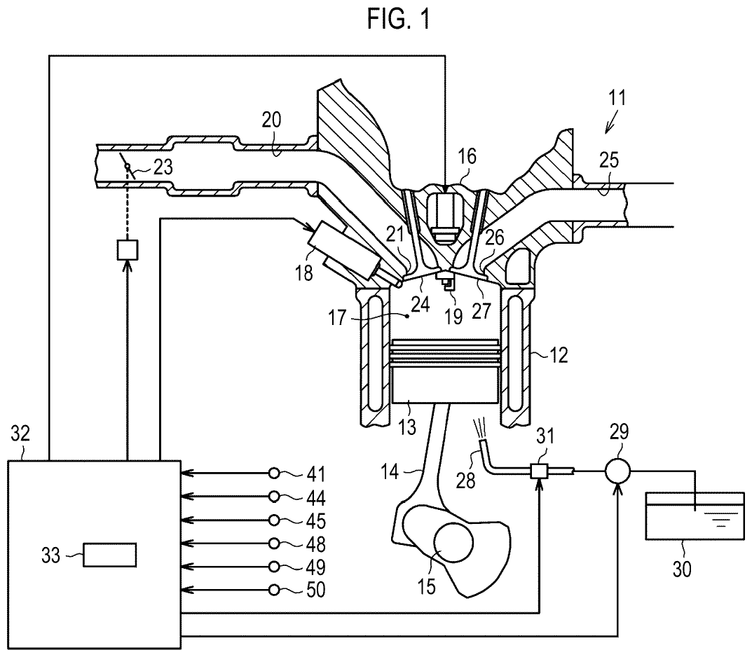

will be described with reference to FIGS. 1 to 4.

As shown in FIG. 1, a piston 13 is disposed in a cylinder block 12 of an internal combustion engine 11. The piston 13 is connected to a crankshaft 15 via a connecting rod 14. A cylinder head 16 is assembled to an upper end of the cylinder block 12. A combustion chamber 17 is provided between a cylinder block 12, a piston 13, and a cylinder head 16 in the internal combustion engine 11.

The cylinder head 16 is provided with an in-cylinder injection valve 18 that directly injects hydrogen gas that is fuel of the internal combustion engine 11 into the combustion chamber 17, and an ignition plug 19 that spark-ignites an air-fuel mixture in the combustion chamber 17. The in-cylinder injection valve 18 and the ignition plug 19 are controlled by a control device 32 of the internal combustion engine 11.

The intake passage 20 of the internal combustion engine 11 is connected to the combustion chamber 17 through the intake port 21. A throttle valve 23 that adjusts an intake air amount of the internal combustion engine 11 is provided in the intake passage 20. An intake valve 24 that opens and closes an intake port 21 is provided in the cylinder head 16. The exhaust passage 25 of the internal combustion engine 11 is connected to the combustion chamber 17 through an exhaust port 26. The cylinder head 16 is provided with an exhaust valve 27 that opens and closes an exhaust port 26.

The internal combustion engine 11 includes an oil jet 28 that injects oil onto a back surface of the piston 13. The oil jet 28 receives the oil discharged from the oil pump 29 and injects the oil. The oil pump 29 pumps up the oil from the oil pan 30 of the internal combustion engine 11 and discharges the oil to the oil jet 28, and for example, an electric oil pump is considered to be employed.

The oil jet 28 includes a valve 31. When the valve 31 is opened, oil is injected from the oil jet 28. When the valve 31 is closed, the injection of the oil from the oil jet 28 is stopped. The injection of the oil from the oil jet 28 through the opening and closing of the valve 31 is controlled by the control device 32 of the internal combustion engine 11.

The injection direction of the oil from the oil jet 28 is set such that the oil is injected toward a place where the oil is positioned on the exhaust port 26 side and the back surface of the piston 13. As the injection direction of the oil of the oil jet 28 is set in this way, the oil injected from the oil jet 28 reaches not only the back surface of the piston 13 but also the cylinder inner wall in the cylinder block 12.

### Details of Piston 13

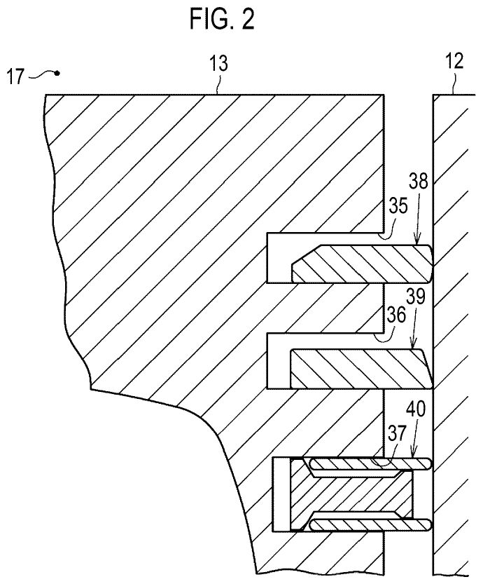

FIG. 2 is an enlarged view of the vicinity of an outer peripheral surface of a head portion of the piston 13. As can be seen from FIG. 2, a plurality of ring grooves 35 to 37 are provided in the outer peripheral surface of the head portion of the piston 13. Piston rings 38 to 40 are housed in ring grooves 35 to 37. The piston rings 38 to 40 are in contact with the cylinder inner wall of the cylinder block 12 to suppress gas leakage from the combustion chamber 17.

### Regarding Control Device 32

The control device 32 shown in FIG. 1 includes a processing circuit 33 that plays a role of a controller. The processing circuit 33 includes a CPU that executes various types of processing in accordance with a program, and a memory in which various types of programs and data are stored. The processing circuit 33 executes various engine controls by the CPU executing the program stored in the memory.

Various sensors are connected to the control device 32. For example, a crank angle sensor 41 that detects a rotation angle of the crankshaft 15, an air flow meter 44 that detects the intake air amount GA, and a water temperature sensor 45 that detects a coolant temperature TW that is a temperature of the coolant after heat exchange in the internal combustion engine 11 are connected to the control device 32. The intake air temperature sensor 48 that detects an intake air temperature THA that is a temperature of intake air of the internal combustion engine 11 and the accelerator sensor 49 that detects an accelerator operation amount ACCP that is an operation amount of an accelerator pedal are connected to the control device 32. Further, the control device 32 is connected to an ignition switch 50 that outputs a command signal IG for stopping or starting the internal combustion engine 11 based on an operation of the driver.

The control device 32 calculates the engine rotation speed NE based on the output signal Scr of the crank angle sensor 41. The control device 32 calculates the engine load factor KL based on the engine rotation speed NE and the intake air amount GA. The engine load factor KL represents a ratio of the current cylinder inflow air amount to the cylinder inflow air amount when the internal combustion engine 11 is operated at a constant speed in a state where the throttle valve 23 is fully opened at the current engine rotation speed NE.

The control device 32 performs injection control of fuel injected from the in-cylinder injection valve 18, ignition control of the ignition plug 19, and opening degree control of the throttle valve 23 as various engine controls. The control device 32 stops the fuel injection from the in-cylinder injection valve 18 in the internal combustion engine 11 that is independently operated and stops the ignition of the ignition plug 19 to stop the independent operation of the internal combustion engine 11. In a case where the control of the opening degree of the throttle valve 23 by the control device 32 is performed, the intake pressure of the internal combustion engine 11, in other words, the pressure on the downstream side of the throttle valve 23 in the intake passage 20 is controlled. Further, the control device 32 also performs the oil injection control of the oil jet 28 through the opening and closing of the valve 31 and the oil discharge amount control of the oil pump 29 as various engine controls.

In the internal combustion engine 11 that uses hydrogen as fuel, condensed water generated by combustion of the fuel is likely to accumulate in the combustion chamber 17. Then, when the condensed water accumulated in the combustion chamber 17 enters between the outer peripheral surface of the head of the piston 13 and the inner wall of the cylinder, the condensed water also enters the ring grooves 35 to 37 that accommodate the piston rings 38 to 40 in the piston 13. When the condensed water enters the ring grooves 35 to 37, the condensed water freezes in an environment of a low outside air temperature while the engine is stopped. In a case where the condensed water in the ring grooves 35 to 37 for accommodating the piston rings 38 to 40 freezes as described above, the behavior of the piston rings 38 to 40 after the next start of the internal combustion engine 11 is inhibited. Therefore, after the internal combustion engine 11 is started, the piston rings 38 to 40 cannot be properly operated. In a case where the piston rings 38 to 40 cannot be properly operated, there is a possibility that a compression failure of gas in the combustion chamber 17 occurs and misfire occurs.

In order to cope with such a situation, when the stop of the internal combustion engine 11 is commanded, the control device 32 executes the intake pressure decrease process and the oil injection amount increase process under a condition that there is a possibility that the condensed water is frozen in the combustion chamber 17 of the internal combustion engine 11 after the stop. The intake pressure decrease process is to decrease the intake pressure of the internal combustion engine. Further, the oil injection amount increase process is to increase the oil injection amount of the oil jet 28. The control device 32 stops the autonomous operation of the internal combustion engine 11 after the intake pressure decrease process and the oil injection amount increase process are ended.

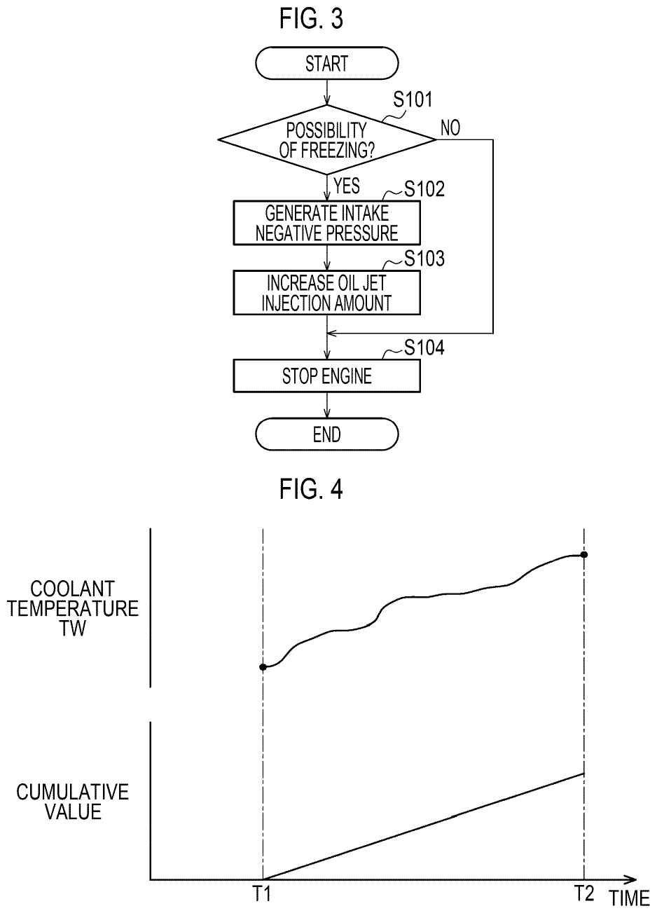

FIG. 3 is a flowchart showing a procedure for stopping the autonomous operation of the internal combustion engine 11. When the driver turns off the ignition switch 50, in other words, when the stop command of the internal combustion engine 11 is issued, the processing circuit 33 of the control device 32 starts a series of processing shown in FIG. 3.

The processing circuit 33 determines whether there is a possibility that the condensed water is frozen in the combustion chamber 17 of the internal combustion engine 11 after the stop, as the processing of step 101 (S101 ) in the series of processing. Whether there is a possibility that the condensed water is frozen in the combustion chamber 17 of the internal combustion engine 11 after the stop is determined based on whether all of the following conditions (A1) to (A3) are satisfied, for example.
(A1) The outside air temperature is lower than a reference value. As the outside air temperature here, for example, the intake air temperature THA may be used, or a value estimated from the intake air temperature THA may be used as the outside air temperature. Further, for the above-described reference value, as a value specified in advance by an experiment or the like may be adopted as the outside air temperature at which the freezing of the condensed water may occur after the stop of the internal combustion engine 11.
(A2) A coolant temperature TW of the internal combustion engine 11 is lower than a reference value. As the reference value here, a value specified in advance by an experiment or the like can be adopted as the coolant temperature at which the freezing of the condensed water can occur after the stop of the internal combustion engine 11.
(A3) A cumulative value of a fuel injection amount from a start of the internal combustion engine 11, in other words, a cumulative value of the fuel injection amount during the operation of the internal combustion engine 11 from an on operation to an off operation of the ignition switch 50 is less than a specified threshold value. The cumulative value of the fuel injection amount has a correlation with a calorific value during the operation of the internal combustion engine 11. The threshold value may be a value specified in advance by an experiment or the like as a value corresponding to the calorific value at which the freezing of the condensed water may occur after the stop of the internal combustion engine 11.

As shown in FIG. 4, when the internal combustion engine 11 is started at timing T1, the coolant temperature TH gradually increases with the passage of time, and the cumulative value of the fuel injection amount gradually increases. Then, in a case where the stop of the internal combustion engine 11 is commanded at timing T2, the determination of whether the condition of (A2) is satisfied is made by using the coolant temperature TW at timing T2. The cumulative value at timing T2 is used to determine whether the condition of (A3) is satisfied.

When at least one of the conditions (A1) to (A3) is not satisfied, a determination is made that there is no possibility that the condensed water is frozen in the combustion chamber 17 of the internal combustion engine 11 after the stop. In this case, the process proceeds to S104. As the processing of S104, the processing circuit 33 stops the autonomous operation of the internal combustion engine 11 by stopping the fuel injection by the in-cylinder injection valve 18 and the ignition by the ignition plug 19. Thereafter, the processing circuit 33 ends the series of processing.

When all the conditions from (A1) to (A3) are satisfied, determination is made that there is a possibility that the condensed water is frozen in the combustion chamber 17 of the internal combustion engine 11 after the stop. In this case, the process proceeds to S102 corresponding to the intake pressure decrease process described above. As the processing of S102, the processing circuit 33 decreases the intake pressure of the internal combustion engine 11 by controlling the throttle valve 23 of the internal combustion engine 11 to a closed position. As the intake pressure decreases, the pressure in the combustion chamber 17 also decreases. Thereafter, the process proceeds to S103 corresponding to the above-described oil injection amount increase process. As the processing of S103, the processing circuit 33 controls the oil pump 29 such that the oil discharge amount increases, thereby increasing the oil injection amount when the valve 31 is opened to inject the oil from the oil jet 28. Thereafter, the processing circuit 33 executes the processing after S104.

Next, the operation effect of the control device of the internal combustion engine 11 of the present embodiment will be described.
(1) When a stop of the internal combustion engine 11 is commanded, the intake pressure decrease process and the oil injection amount increase process are executed in a case where there is a possibility that the condensed water is frozen in the combustion chamber 17 of the internal combustion engine 11 after the stop. Then, after the intake pressure decrease process and the oil injection amount increase process are ended, the internal combustion engine 11 is stopped. The decrease in the intake pressure of the internal combustion engine 11 and the increase in the oil injection amount from the oil jet 28 cause the oil blow-by to the combustion chamber 17 intentionally. As a result, the oil is filled from the ring grooves 35 to 37 that accommodate the piston rings 38 to 40 in the piston 13, and thus the oil is mixed with the condensed water that has entered the ring grooves 35 to 37 in the piston 13. As the condensed water in the ring grooves 35 to 37 is mixed with the oil in this way, the freezing point of the condensed water in the ring grooves 35 to 37 is lowered. Therefore, the freezing of the condensed water in the ring grooves 35 to 37 of the piston 13 can be suppressed during the engine stop in the low outside air temperature environment. In addition, the malfunction of the piston rings 38 to 40 due to the freezing of the condensed water in the ring grooves 35 to 37 of the piston 13 can be suppressed.
(2) When the stop of the internal combustion engine 11 is commanded, in the following cases, there is a possibility that the condensed water is frozen in the combustion chamber 17 of the internal combustion engine 11 after the stop. That is, when the outside air temperature and the coolant temperature TW are each lower than a specified reference value, and the cumulative value of the fuel injection amount from the start of the internal combustion engine 11 is lower than a specified threshold value, there is a possibility that the condensed water may freeze in the combustion chamber 17 of the internal combustion engine 11 after the stop. In such a case, the intake pressure decrease process and the oil injection amount increase process can be appropriately executed.
(3) In the intake pressure decrease process, the throttle valve 23 of the internal combustion engine 11 is controlled to the closed position. As a result, the intake pressure of the internal combustion engine 11 can be effectively decreased.
(4) In the oil injection amount increase process, the oil discharge amount from the oil pump 29 can be increased by controlling the oil pump 29 that is an electric oil pump. As a result, the oil injection amount from the oil jet 28 when the valve 31 is opened can be effectively increased.

The above-described embodiment can be modified as follows, for example. The embodiment described above and the following modifications can be carried out in combination within a technically consistent range.
The oil pump 29 may be a mechanical oil pump driven by the internal combustion engine 11 instead of the electric oil pump. In this case, the oil pump 29 is driven by the rotation of the crankshaft 15, and thus oil is discharged from the oil pump 29. The oil discharge amount of the oil pump 29 increases as the engine rotation speed increases. The processing circuit 33 of the control device 32 is configured to control the internal combustion engine 11 such that the oil discharge amount from the oil pump 29 increases through the increase in the engine rotation speed as the oil injection amount increase process. With this configuration, the engine rotation speed is increased through the control of the internal combustion engine 11 in the oil injection amount increase process. As a result, the oil discharge amount from the oil pump 29 can be increased, so that the oil injection amount from the oil jet 28 can be effectively increased.

As the intake pressure decrease process, the intake pressure of the internal combustion engine 11 is decreased by controlling the throttle valve 23 to the closed position, but the intake pressure of the internal combustion engine 11 may be decreased by changing the opening and closing timing of the intake valve 24 instead of the above.

In order to determine whether there is a possibility that the condensed water is frozen in the combustion chamber 17 of the internal combustion engine 11 after the stop, determination is made as to whether all the conditions of (A1) to (A3) are satisfied, but the present disclosure is not limited thereto. For example, the possibility that the condensed water is frozen in the combustion chamber 17 of the internal combustion engine 11 after the stop may be determined based on the fact that two of the conditions of (A1) to (A3) are satisfied. Further, a determination may be made that there is a possibility that the condensed water is frozen in the combustion chamber 17 of the internal combustion engine 11 after the stop based on the fact that one of the conditions of (A1) to (A3) is satisfied.

The internal combustion engine 11 does not necessarily use hydrogen as fuel, and may use other fuels, such as gasoline.

What is claimed is:

1. A control device for an internal combustion engine, the control device being applied to an internal combustion engine including an oil jet configured to inject oil onto a back surface of a piston or an inner wall of a cylinder, the control device comprising a controller configured to control an intake pressure of the internal combustion engine and an oil injection amount of the oil jet and stop the internal combustion engine based on a command to stop the internal combustion engine,
wherein the controller is configured to execute, when the command to stop the internal combustion engine is issued, an intake pressure decrease process of decreasing the intake pressure of the internal combustion engine and an oil injection amount increase process of increasing the oil injection amount of the oil jet, under a condition that there is a possibility of condensed water freezing in a combustion chamber of the internal combustion engine after the internal combustion engine is stopped, and stop the internal combustion engine after the intake pressure decrease process and the oil injection amount increase process are ended.

2. The control device according to claim 1, wherein the controller is configured to execute, when the command to stop the internal combustion engine is issued, the intake pressure decrease process and the oil injection amount increase process under the condition that there is the possibility of the condensed water freezing in the combustion chamber of the internal combustion engine after the internal combustion engine is stopped based on an outside air temperature and a coolant temperature of the internal combustion engine being lower than respective specified reference values and based on a cumulative value of an fuel injection amount since a start of the internal combustion engine being lower than a specified threshold value.

3. The control device according to claim 1, wherein the intake pressure decrease process is a process of adjusting a throttle valve of the internal combustion engine toward a closed position.

4. The control device according to claim 1, wherein:
the oil jet is configured to receive oil discharged from an electric oil pump and inject the oil; and
the oil injection amount increase process is a process of controlling the electric oil pump such that an oil discharge amount of the electric oil pump is increased.

5. The control device according to claim 1, wherein:
the oil jet is configured to receive oil discharged from a mechanical oil pump driven by the internal combustion engine and inject the oil; and
the oil injection amount increase process is a process of controlling the internal combustion engine such that an oil discharge amount of the mechanical oil pump is increased through an increase in an engine rotation speed.
